(19) United States
(12) Patent Application Publication
(10) Pub. No.: US 2009/0168135 A1
(43) Pub. Date: Jul. 2, 2009

(54) OPTICAL ACTUATOR

(75) Inventors: Ching-Hsiang YU, Taoyuan Hsien (TW); Chia-Chi WU, Taoyuan Hsien (TW); Fu-Mei HSU, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC.

(21) Appl. No.: 12/142,363

(22) Filed: Jun. 19, 2008

(30) Foreign Application Priority Data
Dec. 26, 2007 (TW) 096150225

(51) Int. Cl. G02B 26/08

(52) U.S. Cl. 359/221.2

(57) ABSTRACT

An optical actuator includes a base, a carrier, an optical element, two rotation structures and two actuating components. The carrier is disposed over the base. The optical element is disposed in the carrier. The rotation structures are pivotally connected to two sides of the carrier. The actuating components drive the carrier to rotate an angle according to the rotation structures.

### CROSS REFERENCE TO RELATED APPLICATIONS

This Non-provisional application claims priority under 35 U.S.C. §119(a) on Patent Application No(s). 096150225 filed in Taiwan, Republic of China on Dec. 26, 2007, the entire contents of which are hereby incorporated by reference.

### BACKGROUND OF THE INVENTION

1. Field of Invention

The present invention relates to an actuator and, in particular, to an optical actuator.

2. Related Art

In general, an optical actuator is applied to a projection system in order to increase the number of pixels and smooth an image. The projection system includes an image generating device and a projection lens module. The image generating device generates the image according to the technology of digital micro-mirror devices (DMDs), three liquid crystal displays (3LCD) or liquid crystal on silicon (LCOS) panels. Then, the projection lens module projects the image onto a screen. The optical actuator is disposed between the image generating device and the projection lens module, and swings to increase the number of pixels and smooth the image.

Regarding to the limitation of space and driving mode, most optical actuators adopt the optical reflective optical elements. However, only the transmissive optical elements can be applied to lens modules. Thus, the applications of the optical actuators are restricted, so that the user can not choose the optimum optical actuator for variant demands.

### SUMMARY OF THE INVENTION

In view of the foregoing, the invention is to provide an optical actuator that has a novel rotation structure, which can be used in reflective and transmissive optical actuators so as to extend the application scope.

To achieve the above, the present invention discloses an optical actuator including a base, a carrier, an optical element, at least two rotation structure and at least two actuating components. The carrier is disposed over the base. The optical element is disposed in the carrier. The rotation structures are pivotally connected the base and the carrier. The actuating components drive the carrier to rotate an angle according to the rotation structures.

In the optical actuator of the present invention, the carrier includes a space for accommodating the optical element. The carrier has a bottom surface and at least two protrusions extending downwards from the bottom surface of the carrier. The rotation structures are disposed corresponding to the protrusions. The base includes a supporting portion connecting with the rotation structures. The rotation structures are disposed on a top surface of the supporting portion, or disposed at two sides of the supporting portion, respectively. The supporting portion and the base are integrally formed as a single piece. The actuating components are disposed on the top surface of the base. The optical element is a reflective optical element.

In addition, the carrier further includes an opening, and the optical element is disposed in the opening. At least two supporting portions extend upwards from the periphery of the base. The rotation structures are connected with the corresponding supporting portions, respectively. Alternatively, at least two protrusions extend outwards from the lateral side of the carrier. The rotation structures are connected with the corresponding protrusions and then connected with the corresponding supporting portions. The base has a through hole, and the actuating components are disposed at the lateral sides of the base and located in the through hole. The optical element is a transmissive optical element, so that a light beam can pass through both the opening and the through hole.

The actuating component includes a voice coil motor or a piezoelectric actuator. The optical actuator can be applied to a projection system such as a front projection system or a rear projection system.

As mentioned above, the optical actuator of the present invention has two rotation structures configured opposite to each other and disposed on one side or opposite lateral sides of the carrier. Compared with the prior art, the present invention can be modified according to the product demands. In addition, the present invention can also be applied to transmissive optical actuator, so that the transmissive optical actuator can be commercialized, thereby increasing the application scope thereof.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1A is a top view of an optical actuator according to a first embodiment of the present invention;

FIGS. 1B and 1C are schematic illustrations showing the action of the optical actuator of FIG. 1A;

FIG. 2A is a top view of an optical actuator according to a second embodiment of the present invention;

FIGS. 2B and 2C are schematic illustrations showing the action of the optical actuator of FIG. 2A;

FIG. 3A is a top view of an optical actuator according to a third embodiment of the present invention;

FIG. 3B is a lateral view of the optical actuator of FIG. 3A;

FIG. 4A is a top view of an optical actuator according to a fourth embodiment of the present invention; and

FIG. 4B is a lateral view of the optical actuator of FIG. 4A.

### DETAILED DESCRIPTION OF THE INVENTION

The present invention will be apparent from the following detailed description, which proceeds with reference to the accompanying drawings, wherein the same references relate to the same elements.

### First Embodiment

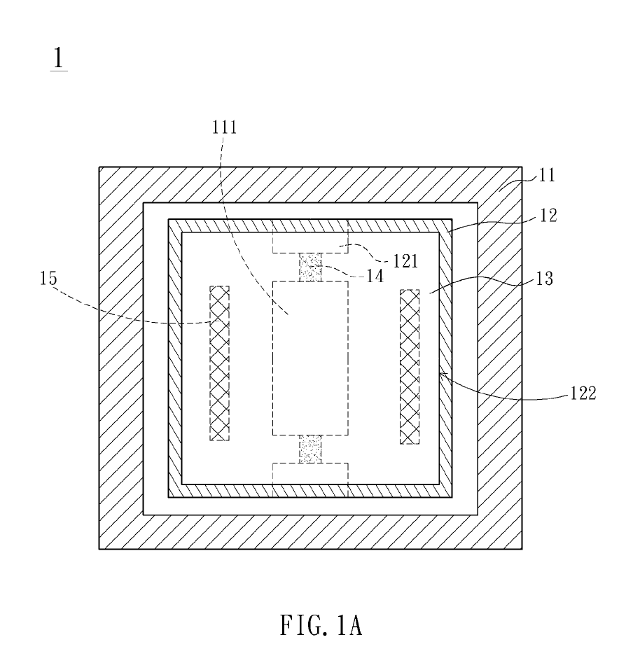

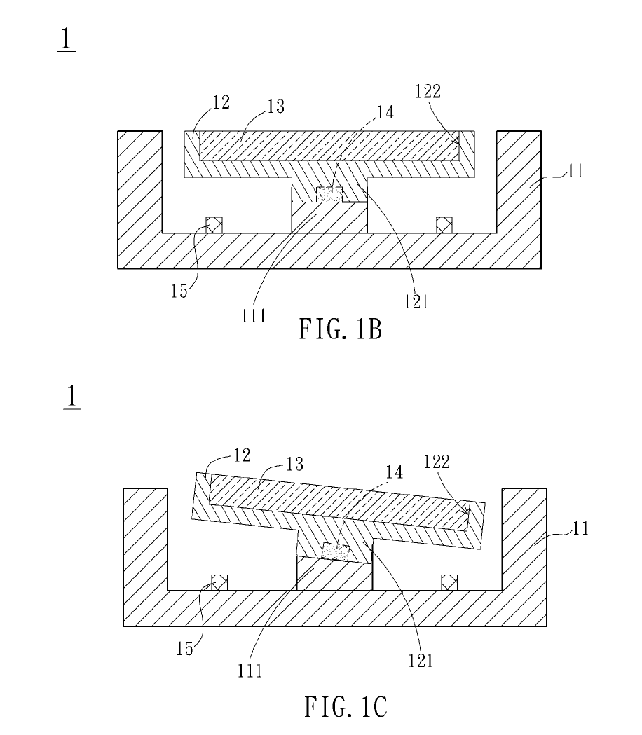

Please refer to FIGS. 1A, 1B and 1C. FIG. 1A is a top view of an optical actuator according to a first embodiment of the present invention. FIGS. 1B and 1C are schematic illustrations showing the action of the optical actuator of FIG. 1A.

An optical actuator 1 according to the first embodiment includes a base 11, a carrier 12, an optical element 13, two rotation structures 14 and two actuating components 15. The carrier 12 is disposed in the base 11 and has a space 122 for accommodating the optical element 13. As shown in FIG. 1B, the two actuating components 15 are disposed on the top surface of the base 11 and located at two opposite sides of the supporting portion 111 of the base 11. The actuating components 15 can drive the carrier 12 to rotate an angle. In the embodiment, the optical element 13 is a reflective optical element.

As shown in FIGS. 1B and 1C, the rotation structures 14 is shown by perspective, and the connection between the rotation structures 14 and the carrier 12 will be described herein below. In the embodiment, the carrier 12 has two protrusions 121, which extend downwards from the bottom surface of the carrier 12 and are respectively disposed at two sides of the supporting portion 111. The two rotation structures 14 are respectively disposed between the supporting portion 111 and two protrusions 121 as shown in FIG. 1A. Thus, the two protrusions 121 are connected with two sides of the supporting portion 111, respectively, so that the carrier 12 can be connected to the base 11. When the actuating components 15 function by, for example, magnetic suction, the carrier 12 can be swung according to the rotation structures 14, so that the carrier 12 can tilt with an angle related to the base 11. Furthermore, the optical actuator 1 can be applied to a projection system, such as a front projection system or a rear projection system, to achieve the effects of increased pixels and image offset.

In the first embodiment, the actuating component 15 can be, for example but not limited to, a voice coil motor (VCM) or a piezoelectric actuator (PZT). In addition, the rotation structures 14 and the protrusions 121 can be integrally formed as a single piece, and the base 11 and the supporting portion 111 can also be integrally formed as a single piece. Therefore, the assembling procedure of the optical actuator 1 can be rapider and simpler.

### Second Embodiment

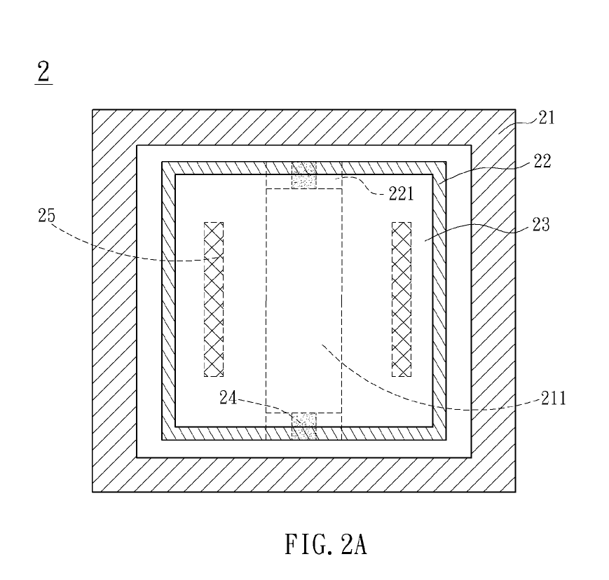

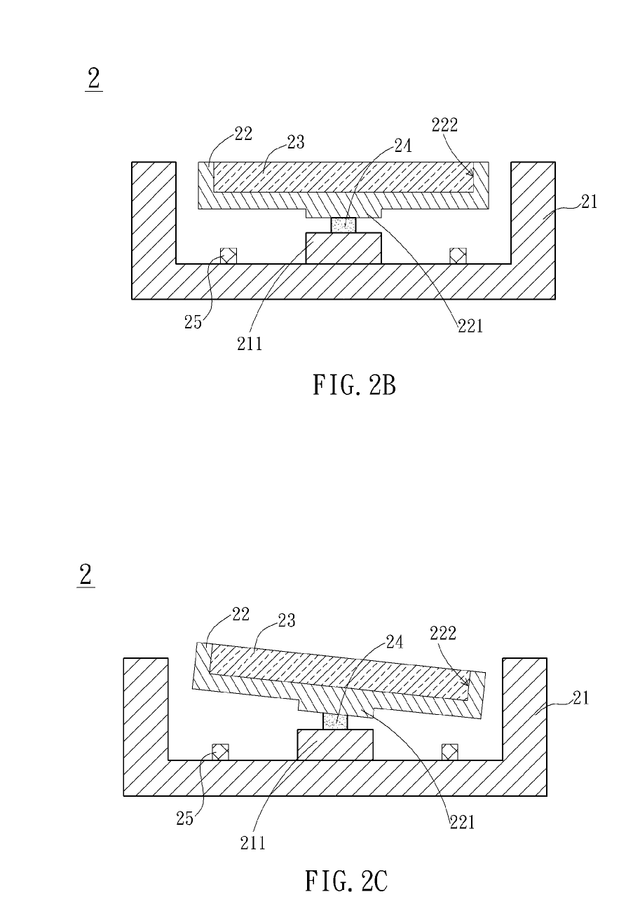

FIG. 2A is a top view of an optical actuator according to a second embodiment of the present invention. FIG. 2B is a schematic illustration showing the action of the optical actuator of FIG. 2A. As shown in FIGS. 2A and 2B, an optical actuator 2 according to the second embodiment includes a base 21, a carrier 22, an optical element 23, two rotation structures 24 and two actuating components 25. The carrier 22 has two protrusions 221 extending downwards from the bottom surface of the carrier 22. The base 21 has a supporting portion 211 disposed thereon. The two protrusions 221 are connected with the supporting portion 211 of the base 21 through the two rotation structures 24. The difference between the first and second embodiment is in that the rotation structures 24 of the second embodiment are disposed on the top surface of the supporting portion 211. When the actuating components 25 function, the carrier 22 can be swung according to the rotation structures 24 so that the carrier 22 can tilt with an angle related to the base 21. The advantage of the optical actuator 2 of the second embodiment is the same as that of the optical actuator 1 of the first embodiment, so the detailed description will be omitted.

As mentioned above, the first and second embodiments are both applied with the reflective optical element, such as the optical actuator. Of course, they can be applied to different applications depending on the product demands.

### Third Embodiment

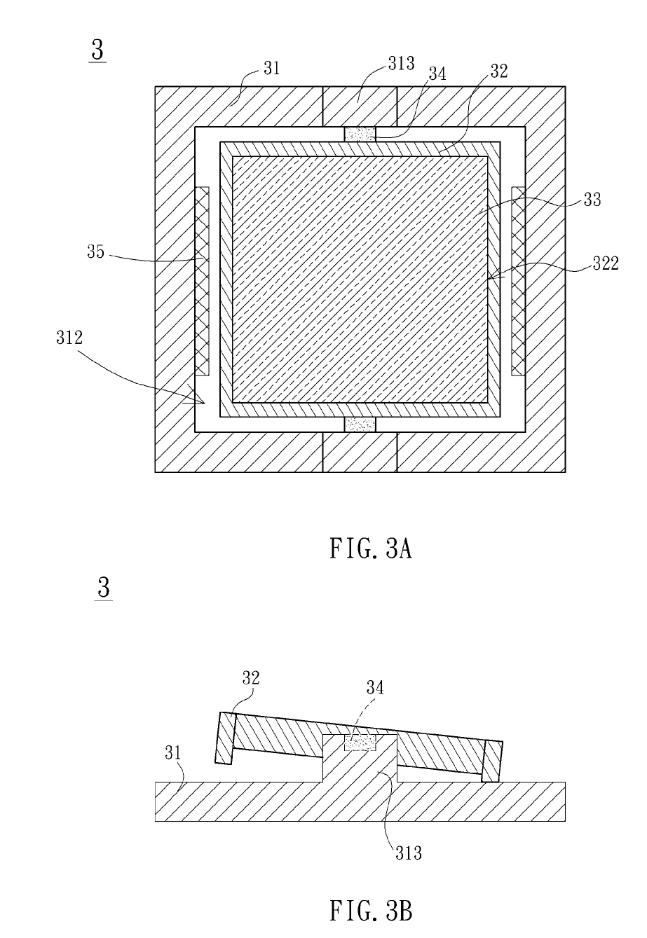

With reference to FIGS. 3A and 3B, the present invention can be also applied to transmissive optical actuator. FIG. 3A is a top view of an optical actuator according to a third embodiment of the present invention. FIG. 3B is a lateral view of the optical actuator of FIG. 3A. As shown in FIGS. 3A and 3B, an optical actuator 3 according to the third embodiment includes a base 31, a carrier 32, an optical element 33, two rotation structures 34 and two actuating components 35. In the embodiment, the base 31 and the carrier 32 are both frame structures. The carrier 32 is disposed in a through hole 312 of the base 31. The carrier 32 has an opening 322 for accommodating the optical element 33. The two actuating components 35 are located in the through hole 312 and disposed at two opposite lateral sides of the base 31, respectively. Thus, the actuating components 35 can drive the carrier 32 to rotate an angle. In the third embodiment, the optical element 33 is a transmissive optical element.

As shown in FIG. 3B, the rotation structures 34 are shown by perspective, and the connection between the rotation structures 34 and the carrier 32 will be described herein below. In the embodiment, the base 31 has two supporting portions 313, which extend upwards from two opposite sides of the base 31 and are connected with two rotation structures 34, respectively. Thus, the two rotation structures 34 are respectively disposed at opposite two sides of the carrier 32. When the actuating components 35 function, the carrier 32 can be swung according to the rotation structures 34 so that the light beam passing through the opening 322 and the through hole 312 can have an offset in angle. Therefore, the optical actuator 3 can be applied to a projection system, such as a front projection system or a rear projection system, to achieve the effects of increased pixels and image offset. In addition, the present invention can achieve the commercialization of the transmissive optical actuator, thereby increasing the application scope thereof.

In the third embodiment, the actuating component 35 can be, for example but not limited to, a voice coil motor (VCM) or a piezoelectric actuator (PZT). In addition, the rotation structures 34 and the carrier 32 can be integrally formed as a single piece, so that the assembling procedure of the optical actuator 3 can be rapider and simpler.

### Fourth Embodiment

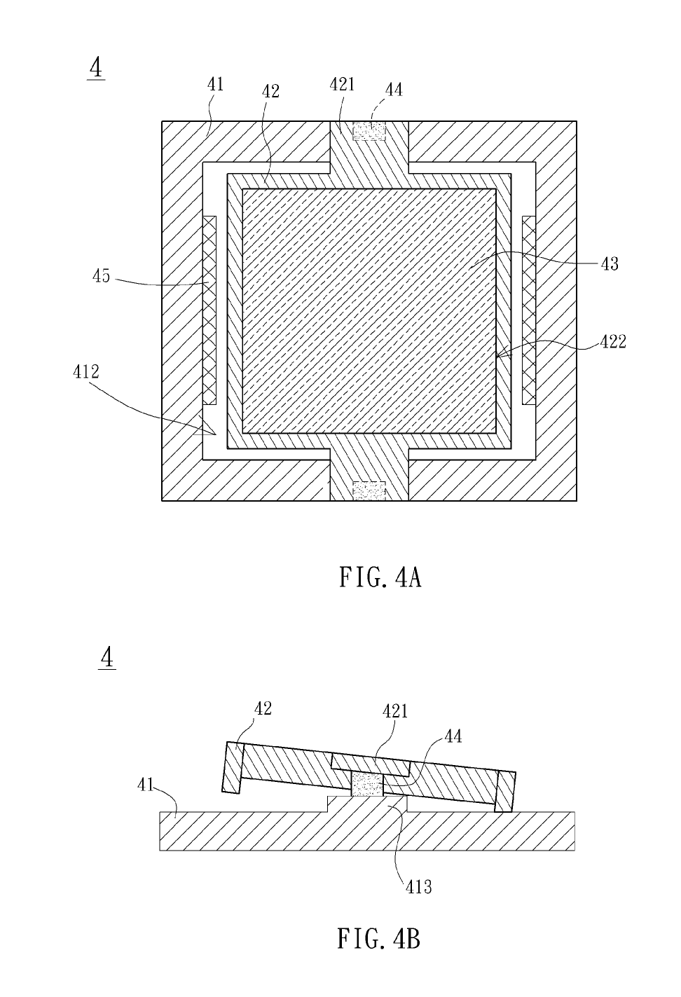

FIG. 4A is a top view of an optical actuator according to a fourth embodiment of the present invention. FIG. 4B is a lateral view of the optical actuator of FIG. 4A. As shown in FIGS. 4A and 4B, an optical actuator 4 according to the fourth embodiment includes a base 41, a carrier 42, an optical element 43, two rotation structures 44 and two actuating components 45. In this embodiment, the base 41 and the carrier 42 are both frame structures as well. Two supporting portions 413 extend upwards from two opposite sides of the base 41, respectively. The carrier 42 has two protrusions 421 extending outwards from two opposite lateral sides of the carrier 42, respectively. The two supporting portions 413 are connected with the corresponding two protrusions 421, respectively, through the two rotation structures 44. Thus, the carrier 42 and the base 41 can be pivotally connected with each other. When the actuating components 45 function, the carrier 42 can be swung according to the rotation structures 44 so that the light beam passing through the opening 422 and the through hole 412 can have an offset in angle. The advantage of the optical actuator 4 of the fourth embodiment is the same as that of the optical actuator 3 of the third embodiment, so the detailed description will be omitted.

As mentioned above, the third and fourth embodiments are both applied with the transmissive optical element. Of course, they can be applied to different applications depending on the product demands.

In summary, the optical actuator of the present invention can be modified according to the product demands. In addition to the reflective optical element, the present invention can also be applied to transmissive optical actuator, so that the transmissive optical actuator can be commercialized, thereby increasing the application scope thereof.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. An optical actuator, comprising:
a base;
a carrier;
an optical element disposed in the carrier;
a rotation structure disposed between the base and the carrier; and
an actuating component for driving the carrier to rotate an angle according to the rotation structures.

2. The optical actuator according to claim 1, wherein the carrier comprises a space for accommodating the optical element.

3. The optical actuator according to claim 2, wherein the carrier has a bottom surface and a protrusion extending downwards from the bottom surface of the carrier, and the rotation structure is disposed corresponding to the protrusion.

4. The optical actuator according to claim 3, wherein the rotation structure and the protrusion are integrally formed as a single piece.

5. The optical actuator according to claim 3, wherein the base has a supporting portion connected with the rotation structure.

6. The optical actuator according to claim 5, wherein the rotation structure is disposed on a top surface or one side of the supporting portion.

7. The optical actuator according to claim 5, wherein the supporting portion and the base are integrally formed as a single piece.

8. The optical actuator according to claim 5, wherein the rotation structure is disposed between the protrusion and the supporting portion.

9. The optical actuator according to claim 2, wherein the actuating component is disposed on a top surface of the base.

10. The optical actuator according to claim 1, wherein the optical element is a reflective optical element or a transmissive optical element.

11. The optical actuator according to claim 1, wherein the carrier comprises an opening, and the optical element is disposed in the opening.

12. The optical actuator according to claim 11, wherein the base has a supporting portion extending upwards from a periphery of the base.

13. The optical actuator according to claim 12, wherein the rotation structure is correspondingly connected with the supporting portion.

14. The optical actuator according to claim 12, wherein the carrier further has a protrusion extending outwards from a lateral side of the carrier, and the rotation structure is correspondingly connected with the protrusion.

15. The optical actuator according to claim 14, wherein the rotation structure is correspondingly connected with the supporting portion.

16. The optical actuator according to claim 11, wherein the base further has a through hole, and the actuating component is disposed at the lateral side of the base and located in the through hole.

17. The optical actuator according to claim 16, wherein the optical element is a transmissive optical element, so that a light beam is capable of passing through both the opening and the through hole.

18. The optical actuator according to claim 1, wherein the actuating component comprises a voice coil motor or a piezoelectric actuator.

19. The optical actuator according to claim 1, being applied to a projection system.

20. The optical actuator according to claim 19, wherein the projection system is a front projection system or a rear projection system.
